(19) United States
(12) Patent Application Publication
(10) Pub. No.: US 2008/0217358 A1
(43) Pub. Date: Sep. 11, 2008

(54) DEVICE FOR DISPENSING DRINKS THAT CAN BE ASSOCIATED WITH A SINK

(75) Inventor: STEFANO TAVOLAZZI, VERBANIA-INTRA (IT)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, BENTON HARBOR, MI (US)

(21) Appl. No.: 12/031,991

(22) Filed: Feb. 15, 2008

(30) Foreign Application Priority Data
Feb. 16, 2007 (IT) VA/2007/U/000011

(51) Int. Cl. B67D 5/06

(52) U.S. Cl. 222/144.5

(57) ABSTRACT

A device suitable for dispensing drinks and the like, in particular one that can be used on kitchen sinks and worktops, comprises a cylindrical central body provided with a dispensing nozzle, a device for controlling dispensing and/or mixing, and at least one connection to a source of drinks. The central body of the device provides for a ring-type portion that can be connected to the stem of an ordinary tap system for dispensing water existing on the sink or worktop.

### BACKGROUND OF THE INVENTION

1. Field of the Invention

The present invention has as its subject-matter a device suitable for dispensing drinks and liquid substances in general, and particularly drinks that are carbonated or still, hot or cold, syrups, or even steam.

The state of the art offers drinks dispensers similar to ordinary taps or particular devices called “gun dispensers” used for professional applications in bars and restaurants.

2. Description of the Related Art

In general, known devices suitable for dispensing drinks are very expensive and do not lend themselves easily to domestic applications.

Currently the application of a device suitable for dispensing drinks in a domestic setting means that the user needs to drill the surface of a kitchen sink or worktop, an operation that is not always easy without using skilled labour. Another possibility is to replace an existing tap in a domestic setting, connected to the hot and cold water pipes coming from the outside, by a new device suitable for dispensing drinks, therefore abandoning the traditional use of the tap associated with the sink.

### SUMMARY OF THE INVENTION

The aim of the present invention is to provide a device suitable for dispensing drinks and liquid substances in general in a domestic setting substantially without modifying the arrangement and use of existing taps and without the need to create additional holes.

A typical tap for dispensing water, known per se, comprises a central cylindrical body to which a device for dispensing the flow is connected, at one end of which an aerator is placed, or even a manual flow regulator suitable for selecting and mixing the flow of hot and cold water. These taps are usually installed on a sink surface, typically made of metal or ceramic or on masonry or wooden surfaces using fixing means, typically threaded. The installation of such a device therefore requires the presence of a hole for inserting the device on the support surface.

The present invention concerns a device that can easily be connected to any tap known per se as just described.

This aim is achieved by means of a device having the characteristics specified in the attached claims.

A non-restrictive example of installation of the device according to the invention comprises the following phases: disassembling the current tap and inserting the lower part of the central body of the device according to the invention into the hole now made available; and finally, mounting the tap previously removed in the upper part of the central body of the device.

The connection between the central body of the device according to the invention and the device for dispensing the flow of liquid can be fixed or mobile and can comprise a system suitable for sliding relative to the device for dispensing the flow of liquid with respect to the central body with the aim of allowing greater flexibility of use thereof.

An example embodiment of the device according to the invention can provide for the central body to be connected to two or more devices for dispensing the flow of liquid.

A further example embodiment of the device according to the invention provides for an electronically controlled device comprising a plurality of push-buttons suitable for selecting the dispensing of a plurality of available drinks or liquid substances placed on the outer wall of the central body or on the body for regulating and mixing the flow of liquid.

The device suitable for selecting and dispensing the type of drink can also comprise a device for regulating the temperature of drinks to be dispensed.

The electronically controlled device can comprise a user interface (“display”) capable of informing the user of the characteristic operating parameters of the device (for example the temperature of the drinks dispensed, an indicator of the number of drinks available, a water filter life indicator, or even an indicator of carbon dioxide pressure in a cylinder used for carbonating water or drinks).

The electronically controlled device suitable for selecting and dispensing the type of drink can be of the “RF wireless” type, further simplifying the assembly and appropriate water/electrical connection of the tap.

### BRIEF DESCRIPTION OF THE DRAWINGS

Further advantages and characteristics of a device according to the invention will become obvious from the following detailed description, provided purely by way of non-restrictive example, in which:

FIG. 1 is a side view of a typical tap for domestic use, known per se,

FIG. 2 is a diagrammatic side view of a device according to the invention,

FIG. 3 is a detail, on a larger scale, from FIG. 2,

FIG. 4 is a view that illustrates a way of connecting the device in FIG. 2 and a typical tap known per se; and

FIG. 5 is a view of a variant of the device according to the invention.

### DETAILED DESCRIPTION OF THE PREFERRED EMBODIMENTS

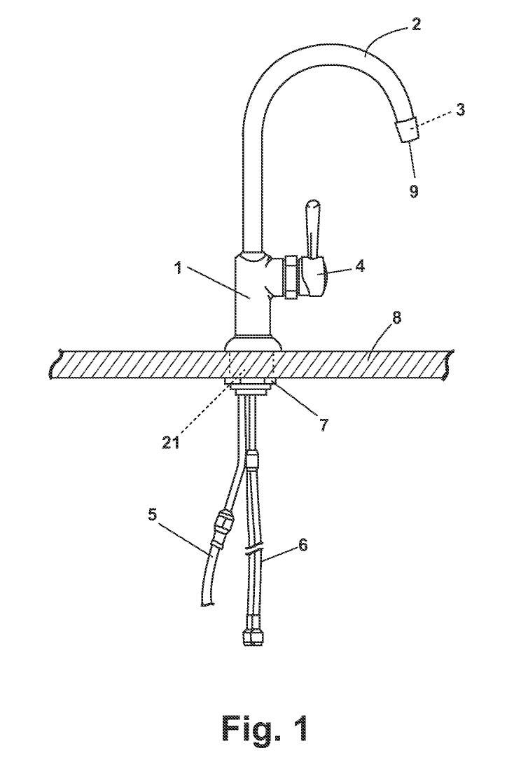

FIG. 1 illustrates a typical tap for a sink, comprising a central body (1), to which a device for dispensing the flow (2) is connected, at the ends of which are arranged an aerator (3), a flow regulator (4) suitable for selecting and mixing the flow of hot and cold water coming from outside, a pipe (6) connected to a municipal distribution network and a pipe (5) connected to an external device suitable for heating the water. The water is then dispensed from the nozzle (9). The central body (1) is inserted into a hole (21) provided on a kitchen worktop (8) and is fixed to the latter by means of a threaded bushing (7).

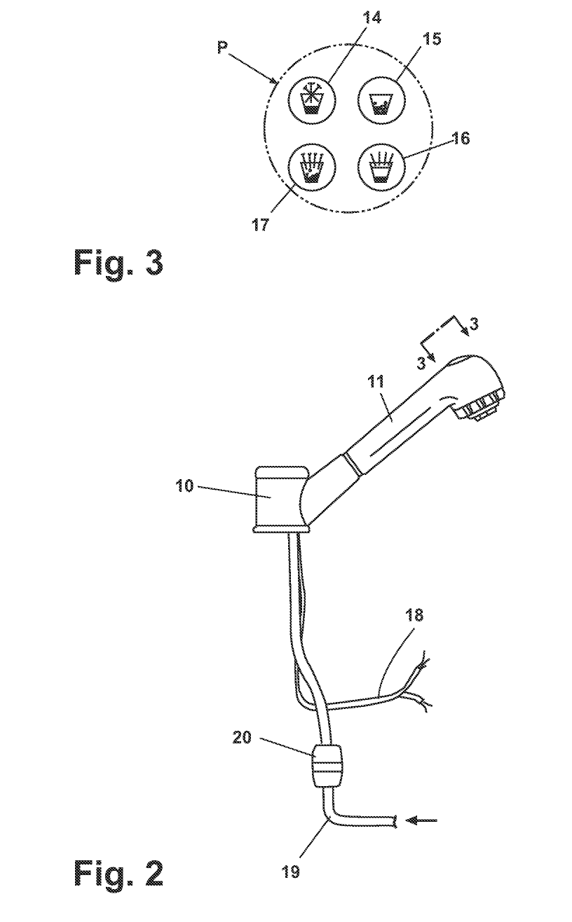

FIG. 2 illustrates the device according to the invention comprising a central body (10), a device for dispensing, regulating and mixing the flow of liquid (11), a electrical cable (18), a connection, by means of a duct, to a source of liquid substances (19), a balancing device (20) suitable for facilitating the insertion of the device for dispensing the flow of liquid into the central body (10) in a phase of non-use, an electronically controlled device comprising a plurality of push-buttons (P) suitable for selecting the dispensing of a plurality of available drinks or liquid substances, for example cold mineral water (key 14), carbonated drinks (key 15), hot infusions (key 16), steam (key 17). Dispensing steam is particularly useful for cleaning dishes.

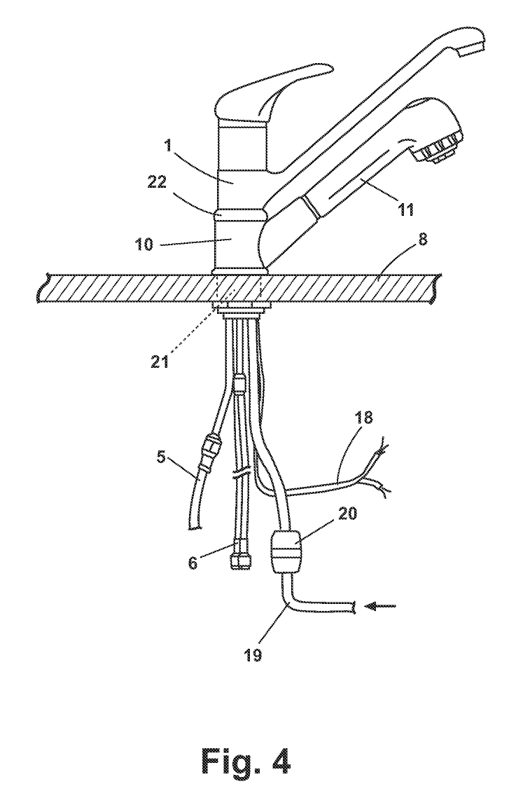

FIG. 4 illustrates a way of connecting the device in FIG. 2 and a typical tap known per se, in which connection by means of the duct (19) to the source of liquid substances is independent of the pipes (5) and (6). The relative rotation between the body (1) of the tap and the central body (10) of the device according to the invention is guaranteed by the interposition of a ring (22) made of antifriction material (for example polyamide).

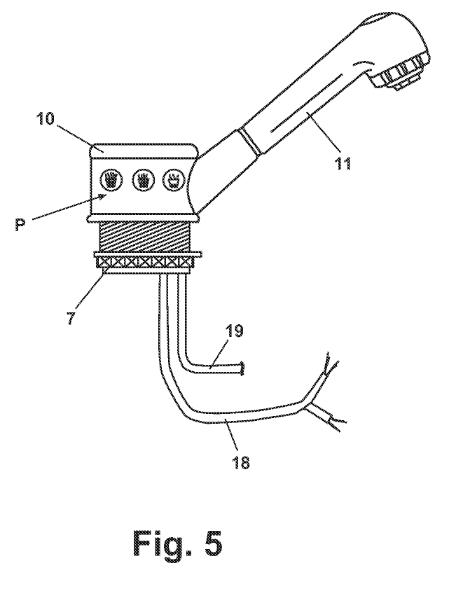

FIG. 5 illustrates a configuration of the device, in which the push-buttons P suitable for selecting and dispensing the type of drink are placed on the side wall of the central body (10).

We claim:

1. A device suitable for dispensing drinks, which can be used in particular on kitchen sinks and worktops, comprising:
a body provided with a dispensing nozzle,
a device for controlling dispensing and/or mixing, and at least one connection to a source of drinks, wherein;
the body provides a portion that can be connected to an ordinary tap system for dispensing water, existing on the sink or worktop.

2. The device according to claim 1, wherein the control device comprises a plurality of push-buttons suitable for selecting the dispensing of a plurality of drinks.

3. The device according to claim 2, wherein the control device is of the electronic type and comprises a user interface capable of informing the user of the characteristic operating parameters of the device.

4. The device according to claim 2, comprising a body that has a cylindrical connection portion from which the dispensing nozzle extends sideways, wherein the push-buttons suitable for selecting and dispensing the type of drink are placed on the side wall of the cylindrical portion.

5. The device according to claim 2, wherein the push-buttons suitable for selecting and dispensing the type of drink are placed on the dispensing nozzle.

6. The device according to claim 2, wherein that a push-button suitable for dispensing steam is provided.

7. The device according to claim 2, comprises the fact of providing the user interface capable of selecting and dispensing the type of drink, of the RF wireless type.

8. The device according to claim 2, further comprising by the fact that the connection by means of the duct to the source of liquid substances is independent of the pipes;
